(19) United States
(12) Patent Application Publication
(10) Pub. No.: US 2013/0192039 A1
(43) Pub. Date: Aug. 1, 2013

(54) SAP CABLE TOOL REMOVER FOR MARINE ELECTRONICS SONAR AND POWER CABLES

(71) Applicant: Ronald Trusty, Wilmington, OH (US)

(72) Inventor: Ronald Trusty, Wilmington, OH (US)

(21) Appl. No.: 13/471,999

(22) Filed: May 15, 2012

Related U.S. Application Data
(60) Provisional application No. 61/593,016, filed on Jan. 31, 2012.

(51) Int. Cl. B25B 13/48; B23P 11/00; B25B 13/06

(52) U.S. Cl. 29/426.5; 81/124.2

(57) ABSTRACT

A wrench to facilitate the attachment and/or removal of a cabled connector from an electronic connection is provided and includes a cylindrical body, a first end having a plurality of first adjacent segments and a plurality of first end segments, a second end disposed at an opposite end of the cylindrical body having a plurality of second adjacent segments and a plurality of second end segments, and a slot defined in the cylindrical body and extending from the first end to the second end.

### CROSS-REFERENCE TO RELATED APPLICATIONS

This application claims the benefit of U.S. Provisional Patent application Ser. No. 61/593, 016 entitled “SAP CABLE TOOL REMOVER FOR MARINE ELECTRONICS SONAR & POWER CABLES” filed on Jan. 31, 2012. The entirety of the above-noted application is incorporated by reference herein.

### ORIGIN

The innovation disclosed herein relates to a tool for removing a cable from an electronic device and more specifically, to a wrench for attaching and removing sonar and power cables to and from a marine sonar device.

### BACKGROUND

In periods of inclement weather, it may be difficult to remove a cabled connector from an electronic device. For example, a marine electronic device, such as a sonar fish finder, includes power cables and sonar cables attached to a back of the sonar device. During colder weather conditions the cables may be difficult to remove due to the limited space on the rear of the device and the cold feeling in the user's hands and fingers. Thus, many boaters leave the sonar device attached to the boat when the boat is not in use (e.g., at night). Thus, the possibility exists that the sonar device can be stolen by simply cutting the cables and removing the device from the boat.

As these devices are expensive, a need exists to facilitate the removal of the cabled connectors to allow boaters to remove the sonar devices when away from the boat.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In aspect of the innovation, a connector attachment/removal device is provided and includes a cylindrical body, a first open end having a plurality of adjacent segments and a plurality of end segments, a second open end at an opposite end of the cylindrical body, and a slot defined in the cylindrical body and extending from the first open end to the second open end, wherein an inside edge of the plurality of adjacent segments and an inside edge of the plurality of end segments have a contoured shape to facilitate the attachment and/or removal of a connector having an elongated member attached thereto to and from a connection.

In another aspect of the innovation a wrench to facilitate the attachment and/or removal of a cabled connector from an electronic connection is provided and includes a cylindrical body, a first open end having a plurality of first adjacent segments and a plurality of first end segments, a second open end disposed at an opposite end of the cylindrical body having a plurality of second adjacent segments and a plurality of second end segments, and a slot defined in the cylindrical body and extending from the first open end to the second open end.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIGS. 1A and 1B are perspective and side views respectively of one example embodiment of a connector attachment/removable device in accordance with an aspect of the innovation.

FIGS. 2A and 2B are perspective side views respectively of another example embodiment of a connector attachment/removable device in accordance with an aspect of the innovation.

FIGS. 3A-3C are perspective, first side, and second side views respectively of another example embodiment of a connector attachment/removable device in accordance with an aspect of the innovation.

FIG. 4A is a block diagram illustration of an external grip means in the form of a T-shaped handle in accordance with an aspect of the innovation.

FIGS. 4B and 4C are first and second side views of the embodiment in FIG. 3A in accordance with an aspect of the innovation.

FIGS. 5-7 are perspective views of an example embodiment of a connector attachment/removable device illustrating a method of removing a cabled connector in accordance with an aspect of the innovation.

FIG. 8 is a flow-chart illustrating the method of FIGS. 5-7 in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

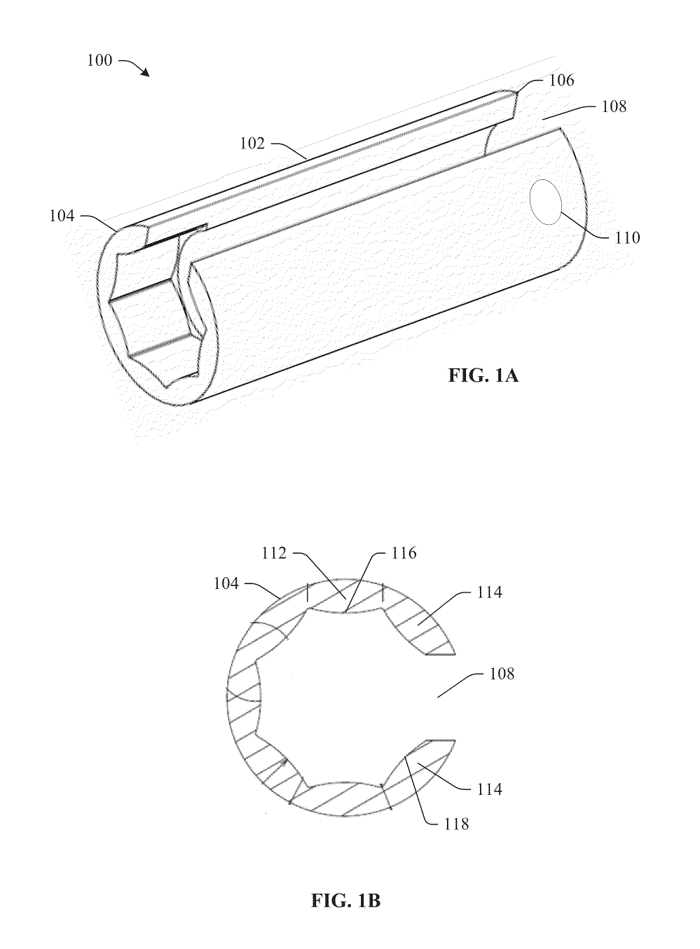

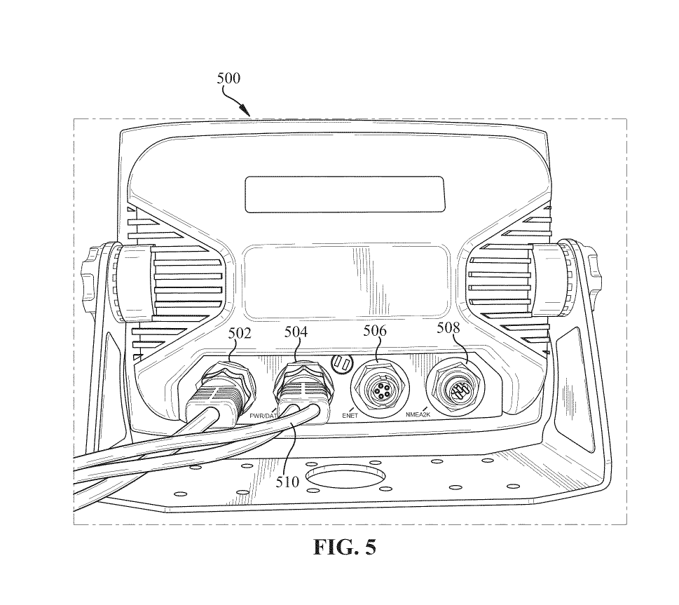

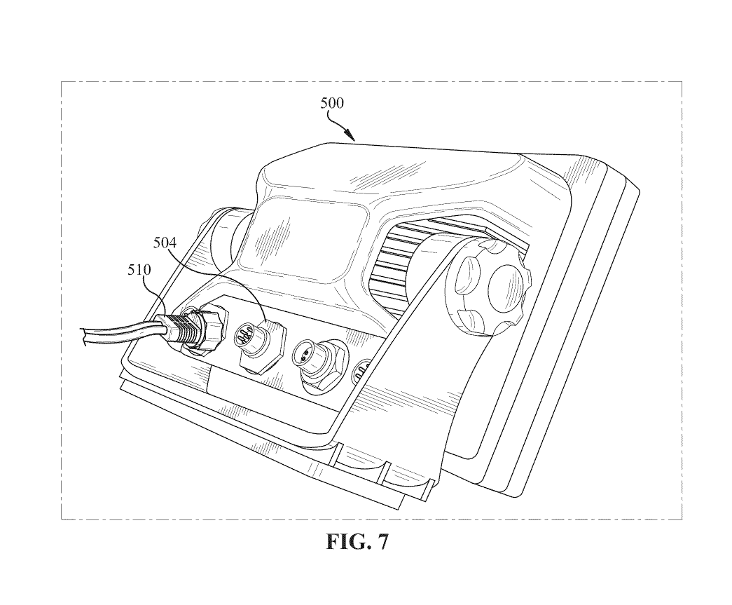

With reference now to the figures, FIGS. 1A and 1B are a perspective view and a side view respectively of one example embodiment of a connector attachment/removable device 100 in accordance with an aspect of the innovation. The device 100 can be used as a socket or wrench to facilitate the attachment and removal of a connector having a cable attached thereto to and from an electronic device. For instance, one example application where the device 100 can be used to facilitate the attachment and removal of power and sonar cables from a marine electronic device, such as a sonar fish finder, as will be described further below in reference to FIGS. 5-7.

Still referring to FIGS. 1A and 1B, the device 100 includes a cylindrical body 102 having a first open end 104, a second open end 106 disposed at an opposite end of the cylindrical body 102, and a slot 108 defined therein that extends from the first end 104 to the second end 106. The slot 108 permits the device 100 to receive an elongated member (described further below), such as but not limited to a power cable, a power cord, a stranded cable, etc. Further, both the first end 104 and the second end 106 are open to facilitate the receipt of the elongated member, as will be described further below. An aperture 110 may be defined in the cylindrical body 102 at any desired location to permit the device 100 to be attached an object and stored in a desired location when not in use. For example, the device 100 may be attached to a key ring, clipped to the marine electronic device, clipped to a boat, etc.

The first end 104 of the device 100 includes contoured adjacent segments 112, which also includes two contoured end segments 114 adjacent to the slot 108. In the example embodiment illustrated in FIGS. 1A and 1B, there are five adjacent segments 112, whereby each adjacent segment 112 has a convex shaped inside edge 116. Similarly, the two end segments 114 have a convex shaped inside edge 118. It is to be appreciated, however, that the innovation is not dependent on the number or contour (shape) of the inside edge 116 of the adjacent segments 112 or dependent on the contour (shape) of the inside edge 118 of the two end segments 114. For example, each inside edge 116, 118 may have a flat, concave, etc. contour or may have ridges or grooves defined therein depending on the shape of the connector. Further, the number of adjacent segments 112 may vary depending on the shape of the connector.

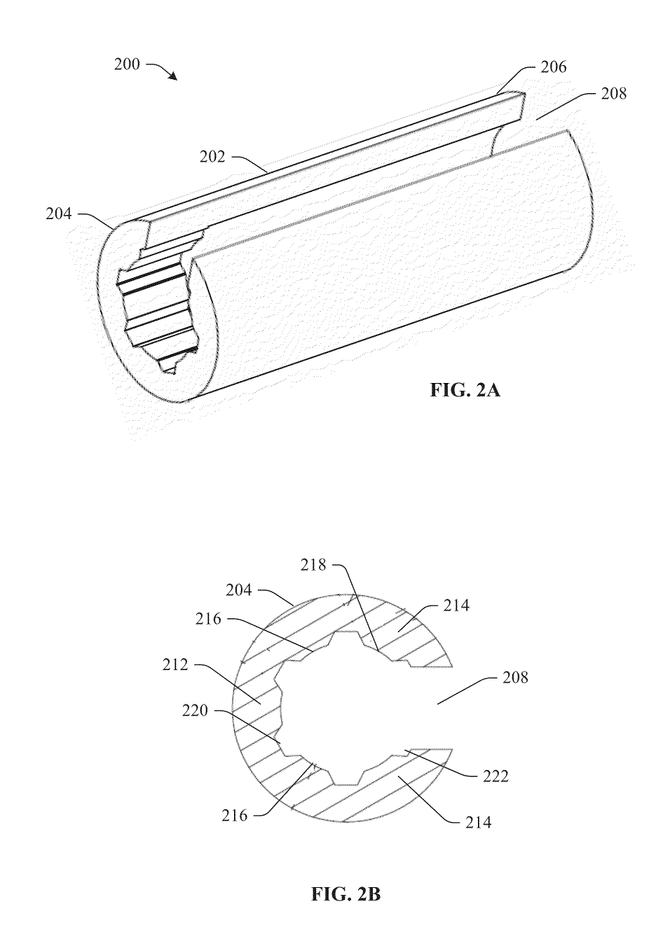

FIGS. 2A and 2B illustrate a perspective view and a side view respectively of another example embodiment of a connector attachment/removable device 200 in accordance with an aspect of the innovation. The device 200 can be used as a socket or wrench to facilitate the attachment and removal of a connector having a cable attached thereto to and from an electronic device. For instance, one example application where the device 200 can be used to facilitate the attachment and removal of power and sonar cables from a marine electronic device, such as a sonar fish finder, as will be described further below in reference to FIGS. 5-7.

The device 200 includes a cylindrical body 202 having a first open end 204, a second open end 206 at an opposite end of the cylindrical body 202, and a slot 208 defined therein that extends from the first end 204 to the second end 206. The slot 208 permits the device 200 to receive an elongated member (described further below), such as but not limited to a power cable, a power cord, a stranded cable, etc. Further, both the first end 204 and the second end 206 are open to facilitate the receipt of the elongated member, as will be described further below.

An inside perimeter 210 of the first end 204 has a shape that facilitates the attachment and removal of a connector having a similar outside perimeter shape. Specifically, the first end 204 includes contoured adjacent segments 212, which includes two contoured end segments 214. In the example embodiment illustrated in FIGS. 2A and 2B, there are three adjacent segments 212, whereby each adjacent segment 212 has a concave shaped inside edge 216. Similarly, the two end segments 214 have a concave shaped inside edge 218. It is to be appreciated, however, that the innovation is not dependent on the number or contour (shape) of the inside edge 216 of the adjacent segments 212 or dependent on the contour (shape) of the inside edge 218 of the two end segments 214. For example, each inside edge 216, 218 may have a flat, concave, etc. contour or may have ridges or grooves defined therein depending on the shape of the connector. Further, the number of adjacent segments 212 may vary depending on the shape of the connector.

Referring specifically to FIG. 2B, a tooth-shaped notch 220 is formed between adjacent segments 214 thus forming multiple tooth-shaped notches 220 around the inside perimeter 210 of the first end 204. Accordingly, a half tooth-shaped notch 222 is formed between the two end segments 214 and the slot 208. As mentioned above, the contour (shape) of the inside perimeter 210 of the first end 204 facilitates the attachment and removal of a connector having a similar shaped outside perimeter.

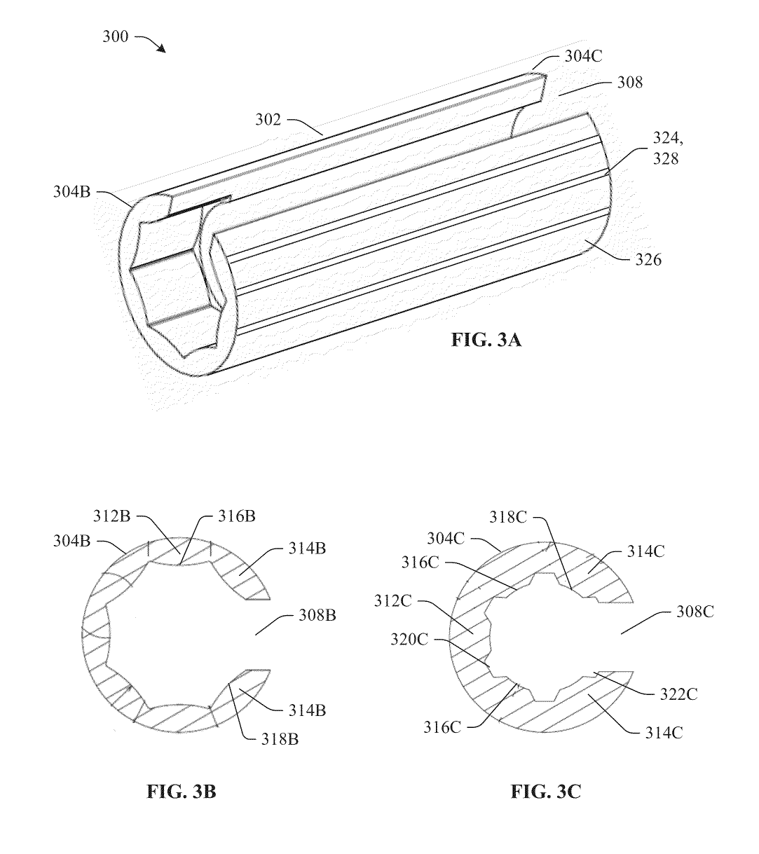

FIGS. 3A-3C illustrate a perspective view, a first side view, and a second side view respectively of another example embodiment of a connector attachment/removable device 300 in accordance with an aspect of the innovation. As in the example embodiments above, the device 300 can be used as a socket or wrench to facilitate the attachment and removal of a connector having a cable attached thereto to and from an electronic device. In this embodiment, however, both ends of the device 300 can be used to attach or remove different sized connectors, thus, reducing the number of devices required to perform the task. To assist the user to quickly identify each end of the device 300, each end can be marked in some manner (e.g. different colors) thereby providing a quick visual identifying means for the user. One example application where the device 300 can be used to facilitate the attachment and removal of power and sonar cables from a marine electronic device, such as a sonar fish finder, as will be described further below in reference to FIGS. 5-7.

Referring specifically to FIG. 3A, the device 300 includes a cylindrical body 302 having a first open end 304B, a second open end 304C at an opposite end of the cylindrical body 302, and a slot 308 defined therein that extends from the first end 304B to the second end 304C. The slot 308 permits the device 300 to receive an elongated member (described further below), such as but not limited to a power cable, a power cord, a stranded cable, etc. Further, both the first end 304B and the second end 304C are open to facilitate the receipt of the elongated member, as will be described further below.

Referring to FIG. 3B, the first end 304B of the device 300 includes contoured adjacent segments 312B, which includes two contoured end segments 314B adjacent to the slot 308. In the example embodiment illustrated in FIG. 3B, there are five adjacent segments 312B, whereby each adjacent segment 312B has a convex shaped inside edge 316B. Similarly, the two end segments 314B have a convex shaped inside edge 318B. It is to be appreciated, however, that the innovation is not dependent on the number or contour (shape) of the inside edge 316B of the adjacent segments 312B or dependent on the contour (shape) of the inside edge 318B of the two end segments 314B. For example, each inside edge 316B, 318B may have a flat, concave, etc. contour or may have ridges or grooves defined therein depending on the shape of the connector. Further, the number of adjacent segments 312B may vary depending on the shape of the connector.

Referring now to FIG. 3C, an inside perimeter 310C of the second end 304C has a shape that facilitates the attachment and removal of a connector having a similar outside perimeter shape. Specifically, the first end 304C includes contoured adjacent segments 312C, which includes two contoured end segments 314C. In the example embodiment illustrated in FIG. 3C, there are three adjacent segments 312C, whereby each adjacent segment 312C has a concave shaped inside edge 316C. Similarly, the two end segments 314C have a concave shaped inside edge 318C. It is to be appreciated, however, that the innovation is not dependent on the number or contour (shape) of the inside edge 316C of the adjacent segments 312C or dependent on the contour (shape) of the inside edge 318C of the two end segments 314C. For example, each inside edge 316C, 318C may have a flat, concave, etc. contour or may have ridges or grooves defined therein depending on the shape of the connector. Further, the number of adjacent segments 312C may vary depending on the shape of the connector.

Still referring to FIG. 3C, a tooth-shaped notch 320C is formed between adjacent segments 314C thus forming multiple tooth-shaped notches 320C around the inside perimeter 310C of the first end 304C. Accordingly, a half tooth-shaped notch 322C is formed between the two end segments 314C and the slot 308. As mentioned above, the contour (shape) of the inside perimeter 310C of the first end 304C facilitates the attachment and removal of a connector having a similar shaped outside perimeter.

Referring back to FIG. 3A, the device 300 may include a means 324 to grip the device 300 to facilitate the attachment and/or removal of connectors. The grip means 324 may be disposed on an outer perimeter 326 of the device 300 and may be in the form of grooves 328 defined in the outer perimeter 326. In other example embodiments, the grip means 324 may include a textured or contoured outer perimeter, a material attached to the outer perimeter that facilitates gripping (e.g., rubber) or any other means that facilitates gripping.

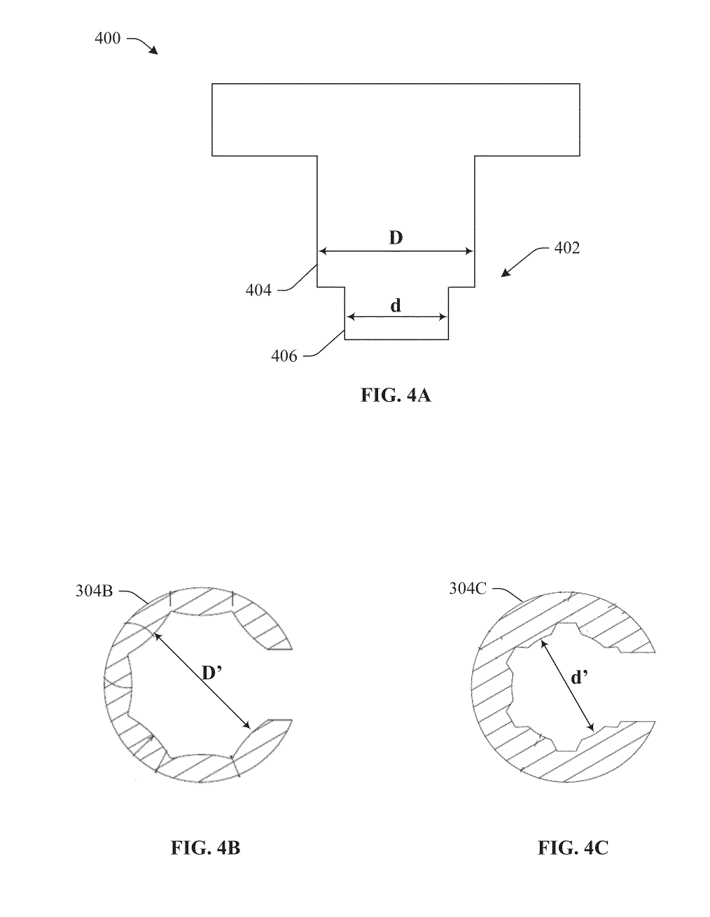

FIG. 4A is a block diagram illustration of an external grip means 400 in the form of a T-shaped handle in accordance with an aspect of the innovation. In certain application, the handle 400 can be used to facilitate the attachment and removal of different sized connectors. Further, the handle 400 can be used with any of the example embodiments disclosed herein. For purposes of illustration, however, the handle 400 will be described in relation to the example embodiment illustrated in FIGS. 3A-3C. It is to be appreciated that although the handle disclosed herein is a T-shaped handle, the handle can be any shape, such as but not limited to, an L-shape, cross shaped, etc.

The handle 400 includes a stepped attachment/removal end 402 having a first (larger) portion 404 and a second (smaller) portion 406. The larger portion 404 has a diameter or width D that corresponds to a diameter D′ of an opening in the first end 304B of the device 300. Similarly, the smaller portion 406 has a diameter or width d that corresponds to a diameter d′ of an opening in the second end 304C. Thus, the same handle 400 can be used on both the first and second end 304B, 304C of the device 300. For example, if the user desires to use the first end 304B of the device 300 to remove a cabled connector, the user can simply insert the smaller portion 406 of the handle 400 into the opening defined in the second end 304C and rotate as desired. Similarly, if the user desires to use the second end 304C to remove a cabled connector, the user can simply insert both the smaller and larger portion 404, 406 into the opening defined in the first end 304B and rotate as desired.

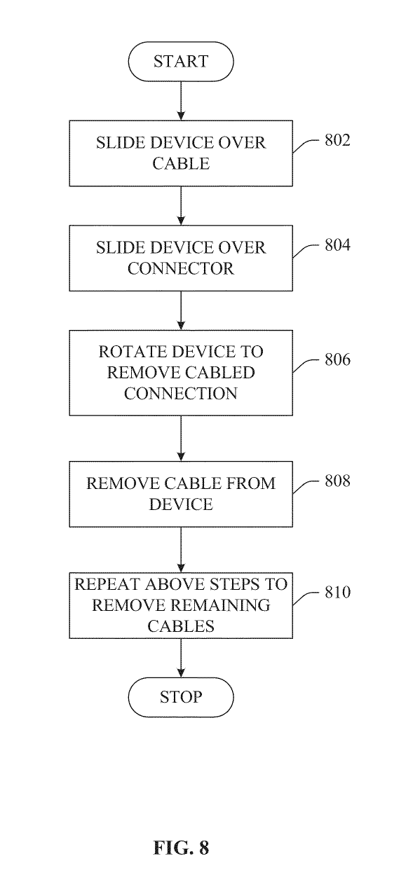

FIGS. 5-8 illustrate the removal of a cabled connector in accordance with an aspect of the innovation. For illustration purposes only, the innovation will be described in assisting the removal of a cabled connector from a marine sonar electronic device using the example device 100 of FIGS. 1A and 1B.

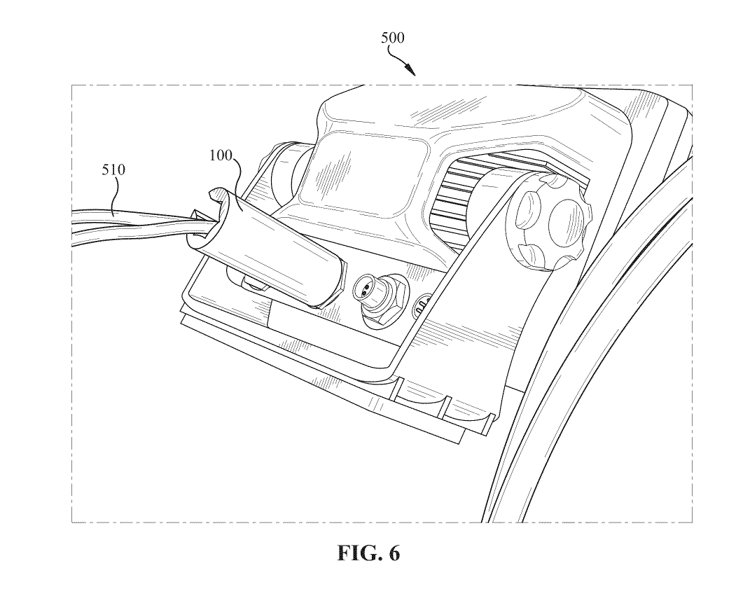

Referring to FIG. 5, the marine device 500 includes a sonar connection 502, a power connection 504, an Ethernet connection 506, and a NEMA connection 508. Referring to FIGS. 6-8, the device 100 is illustrated in removing a power cable 510 from the power connection 504. To remove the power cable 510, at 802, the user simply slides the device over the power cable 510 and at 804, the user then slides the desired end of the device 100 up and over the connector attached to the power cable 510. At 806 the user rotates the device 100 in a direction to remove the power cable 510 from the power connection 504. At 808, the user removes the power cable 510 from the marine device 500. At 810, the user repeats these steps to remove the remaining cabled connections from the marine device 500.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A connector attachment/removal device comprising:
a cylindrical body;
a first open end having a plurality of adjacent segments and a plurality of end segments;
a second open end at an opposite end of the cylindrical body; and
a slot defined in the cylindrical body and extending from the first open end to the second open end,
wherein an inside edge of the plurality of adjacent segments and an inside edge of the plurality of end segments have a contoured shape to facilitate the attachment and/or removal of a connector having an elongated member attached thereto to and from a connection.

2. The device of claim 1, wherein the contoured shape is convex.

3. The device of claim 1, wherein the contoured shape is concave.

4. The device of claim 1 further comprising a tooth-shaped notch disposed between adjacent segments.

5. The device of claim 1 further comprising a hole defined in the cylindrical body to facilitate the attachment of the device to an object for storage.

6. The device of claim 1, wherein the second open end includes a plurality of second adjacent segments having a contoured inside edge different from the plurality of adjacent segments of the first open end and a plurality of second end segments having a contoured inside edge different from the plurality of end segments of the first open end.

7. The device of claim 6 further comprising a tooth-shaped notch disposed between each of the plurality of second adjacent segments.

8. The wrench of claim 1 further comprising a gripping means formed on an outside perimeter of the cylindrical body to facilitate rotation of the wrench.

9. The wrench of claim 1 further comprising a handle having a stepped end, wherein the stepped end has a first portion having a diameter corresponding to an inside diameter of the first open end of the device and a second portion having a diameter that corresponds to an inside diameter of an opening defined in the second open end of the wrench.

10. A wrench to facilitate the attachment and/or removal of a cabled connector from an electronic connection comprising:
a cylindrical body;
a first open end having a plurality of first adjacent segments and a plurality of first end segments;
a second open end disposed at an opposite end of the cylindrical body having a plurality of second adjacent segments and a plurality of second end segments; and
a slot defined in the cylindrical body and extending from the first open end to the second open end.

11. The wrench of claim 10, wherein an inside edge of the plurality of first adjacent segments and an inside edge of the plurality of first end segments have a first contoured shape to facilitate the attachment and/or removal of a connector having an elongated member attached thereto to and from a connection.

12. The wrench of claim 11, wherein an inside edge of the plurality of second adjacent segments and an inside edge of the plurality of second end segments have a second contoured shape to facilitate the attachment and/or removal of a connector having an elongated member attached thereto to and from a connection, wherein the second contoured shape is different than the first contoured shape.

13. The wrench of claim 12, wherein the first contoured shape is convex.

14. The wrench of claim 13, wherein the second contoured shape is concave.

15. The wrench of claim 14, wherein the second open end includes a tooth-shaped notch disposed between adjacent segments.

16. The wrench of claim 16 further comprising a hole defined in the cylindrical body to facilitate the attachment of the device to an object for storage.

17. The wrench of claim 16 further comprising a gripping means formed on an outside perimeter of the cylindrical body to facilitate rotation of the wrench.

18. The wrench of claim 16 further comprising a handle having a stepped end, wherein the stepped end has a first portion having a diameter corresponding to an inside diameter of the first open end of the device and a second portion having a diameter that corresponds to an inside diameter of an opening defined in the second open end of the wrench.

19. A method of removing a connector having an elongated member attached thereto from a connection comprising:
providing a connector attachment/removal device having a first open end, a second open end, and a slot defined in the cylindrical body and extending from the first open end to the second open end;
sliding the connector attachment/removal device over the elongated member;
sliding the connector attachment/removal device over a connection; and
rotating the connector attachment/removal device in a direction to remove the connector from the connection.

20. The method of claim 19 further comprising repeating the method to remove additional connectors having additional elongated members attached thereto from a connection.
